(19) United States
(12) Patent Application Publication
(10) Pub. No.: US 2017/0276395 A1
(43) Pub. Date: Sep. 28, 2017

(54) WOODEN-CABINET FOR AIR CONDITIONING SYSTEM

(71) Applicants: David Nyhof, Shipshewana, IN (US); Michael Nyhof, Shipshewana, IN (US)

(72) Inventors: David Nyhof, Shipshewana, IN (US); Michael Nyhof, Shipshewana, IN (US)

(21) Appl. No.: 15/150,735

(22) Filed: May 10, 2016

Related U.S. Application Data
(60) Provisional application No. 62/314,283, filed on Mar. 28, 2016.

(51) Int. Cl. F24F 13/20; F24F 1/00; F24F 5/00; F21V 33/00; F24F 1/32; A47B 81/00; A47B 55/00; F24F 13/28; F25B 30/02

(52) U.S. Cl. CPC F24F 13/20; F24F 13/28; F24F 1/0003; F24F 5/0096; F25B 30/02; F24F 1/32; A47B 81/00; A47B 55/00; F21V 33/0092; F24F 2011/0068

(57) ABSTRACT

A wooden-cabinet for air conditioning system including a cabinet for housing an air conditioning system wherein the cabinet is depicted in the form of a fireplace or a wood mantel, and the cabinet is preferably made of wood material. The cabinet preferably houses the indoor unit of the air condition system and includes heat pumps, split type heat pumps, split-HVAC, hydronic based heating systems and like. The cabinet comprise a substantially rectangular shaped enclosure having the air inlet, air outlet, components of air condition system, control unit etc. The faux fireplace cabinet comprises an illustrative model of a fireplace defined on the front side of the cabinet.

### CROSS-REFERENCE TO RELATED APPLICATION

The present application is related to and claims priority from prior provisional application Ser. No. 62/314,283, filed Mar. 28, 2016 which application is incorporated herein by reference.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of cabinets and more specifically relates to a wooden-cabinet for an air conditioning system depicting a fireplace or a wood mantel.

### 2. Description of Related Art

Air conditioning systems generally refers to an apparatus for providing conditioned air to enclosed spaces such as rooms, offices, halls, automobiles etc. Air conditioning generally refers to manipulating the properties of air such as temperature, humidity, controlling the amount of dust particles and microorganisms etc. The term air conditioning referred herein generally refers to both heating and cooling of the air.

Various types of such air conditioning apparatuses are commercially available that are developed to address the different needs, for example, different types of air conditioning apparatuses are available for households, offices and big halls. Moreover, air conditioning apparatuses of different capacities are available and the desired size of air conditioning unit could be selected based on the space area that will receive the conditioned air. In addition, the air conditioners that provide both hot and cold air are also commonly used, for example HVAC systems are used in both residential and commercial places. Another form of providing heating means is fireplaces. The use of fireplaces and electrical heating systems has several disadvantages including the drying of the air, which in turn may lead to several health complications such as respiratory disorders. Thus, a need is clear for an improved heating system that does not cause dehumidification of air and further is energy efficient.

Several attempts have been made to solve the above-mentioned problems such as those found in U.S. Pub. Nos. 2012/381,804 to James D. Minogue, and 2005/0199233 to Gary Butler. This art is representative of cabinets. However, none of the above inventions and patents, taken either singly or in combination, is seen to describe the invention as claimed.

Preferably, a cabinet for air conditioning system should provide an apparatus for heating interiors of a building and, yet would operate reliably and be manufactured at a modest expense. Thus, a need exists for a reliable cabinet for air conditioning system to avoid the above-mentioned problems.

### BRIEF SUMMARY OF THE INVENTION

In view of the foregoing disadvantages inherent in the known cabinet art, the present invention provides a novel wood cabinet for air conditioning system. The general purpose of the present invention, which will be described subsequently in greater detail is to provide a wooden cabinet depicting a fireplace or a wood mantel serving as a functional and aesthetic solution for heating and cooling.

A wooden-cabinet for air conditioning system is disclosed herein, in a preferred embodiment, comprising a wood-cabinet for air conditioning assembly having a cabinet, an air-conditioning system with an indoor unit, a blower, and a heat exchanger, an outdoor unit with a compressor, a condenser, and an expansion valve, a wood mantel, and an illustrative model. The wooden-cabinet for air conditioning system comprises the wood-cabinet for air conditioning assembly. The wood-cabinet for air conditioning assembly comprises the cabinet, the wood mantel, and the illustrative model. The illustrative model is a three dimensional model of the fireplace. The illustrative model may further comprise a plurality of illuminations.

The cabinet comprises wood in preferred embodiments. The cabinet is produced in the form a faux-fireplace. The cabinet comprises the air-conditioning system, the illustrative model depicting a fireplace, and the wood mantel. The air-conditioning system comprises the indoor unit and the outdoor unit. The air conditioning system further comprises a control unit; the control unit configured to operate the air conditioning system and comprises a thermostat and an input module, the input module adapted to receive a temperature input. The control unit is able to be remotely operated using a remote control and alternately a smart phone or the like.

The indoor unit and the outdoor unit are in fluid communication through at least two tubings the two or more tubing pass through one or more the apertures defined on any sidewall of the cabinet. The air conditioning system further comprises at least one air filter configured on at least one air inlet. The air conditioning system is preferably a split type HVAC. The indoor unit comprises the blower and the heat exchanger. The indoor unit is in fluid communication to the outdoor unit of the hydronic based heating system; the outdoor unit comprising a heat source and a first heat exchanger in spatial relationship to the heat source. The outdoor unit comprises the compressor, the condenser and the expansion valve.

The cabinet comprises an aperture configured to permit at least two of the tubes of the air conditioning system to pass through. The cabinet is configured to house an indoor unit of the air conditioning system. The air conditioning system further comprises the outdoor unit. The indoor unit and the outdoor unit are in fluid communication through at least two of the tubes. The wood mantel comprises a plurality of side walls defining the wood mantel having an inner volume. The wood mantel is configured to enclose one or more components of the air conditioning system. The wood mantel comprises at least one air inlet(s) defined on at least one sidewalls of the cabinet. The wood mantel comprises at least one air outlet(s) defined on at least one of the sidewalls of the cabinet. The wood mantel comprises an aperture defined on any the sidewall of the cabinet; the aperture configured to permit two or more tubes of the air conditioning system to pass-through. The wooden-cabinet for air conditioning system is structured and arranged for enclosing the air conditioning system to prevent damage to the air conditioning system.

The present invention holds significant improvements and serves as a wood cabinet for air conditioning system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, wood cabinet for air conditioning systems, constructed and operative according to the teachings of the present invention.

FIG. 1 shows a perspective view illustrating a wooden-cabinet for air conditioning system showing a rectangular shaped cabinet according to an embodiment of the present invention.

FIG. 2 is a side view illustrating the wooden-cabinet for air conditioning system comprising a wooden-cabinet for air conditioning system assembly according to an embodiment of the present invention of FIG. 1.

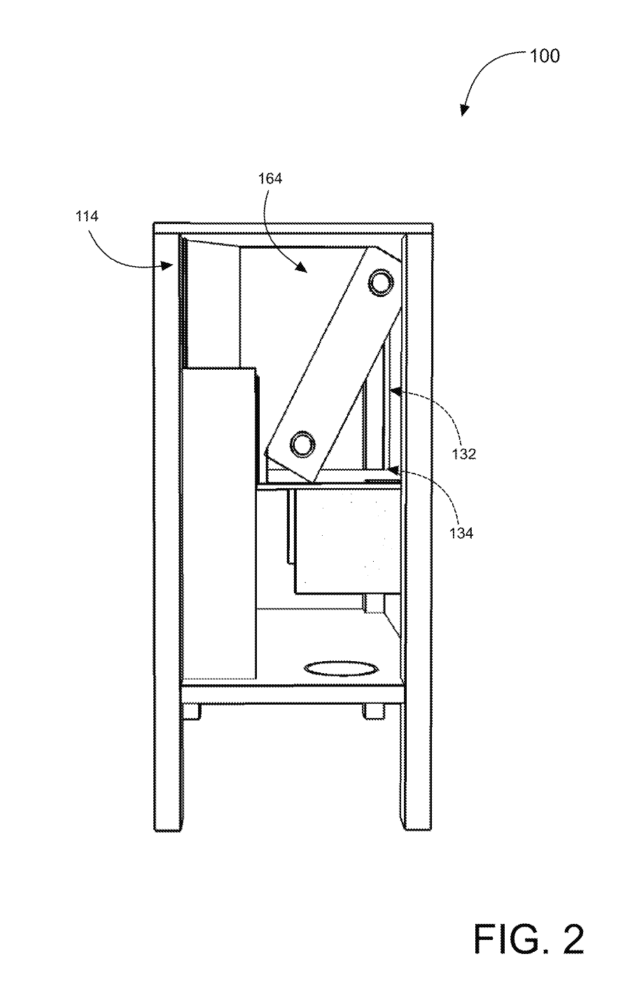

FIG. 3 is a perspective view illustrating the wooden-cabinet for air conditioning system assembly comprising the cabinet according to an embodiment of the present invention of FIGS. 1-2.

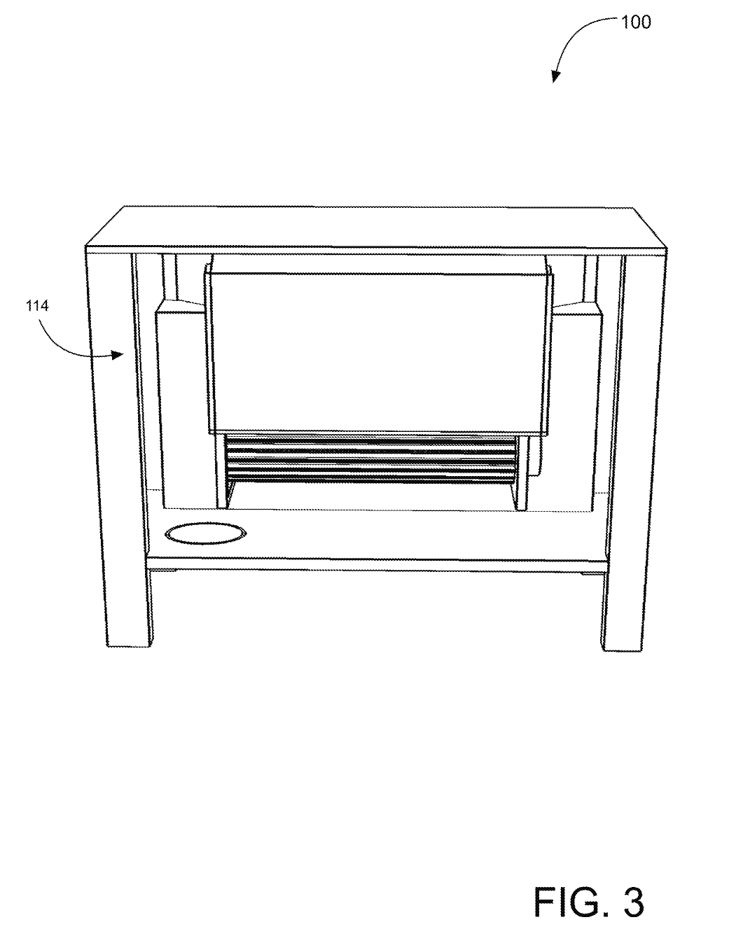

FIG. 4 is a perspective view illustrating the rectangular shaped cabinet according to an embodiment of the present invention of FIGS. 1-3.

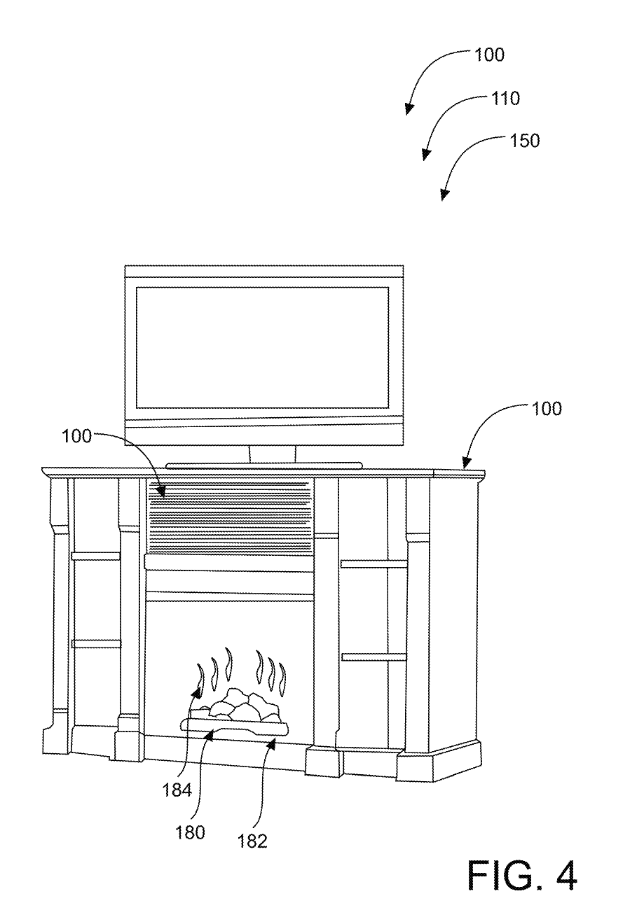

The various embodiments of the present invention will hereinafter be described in conjunction with the appended drawings, wherein like designations denote like elements.

### DETAILED DESCRIPTION

As discussed above, embodiments of the present invention relate to a cabinet for air conditioning system and more particularly to a wood cabinet for air conditioning systems as used to improve the temperature control of a room or building in a functionally-aesthetic device.

Generally speaking, wood cabinet for air conditioning systems (rectangular version) may comprise a 3D rectangular shaped cabinet supported on the four legs. The cabinet is preferably made of wood material and depicts a fireplace. The fireplaces provided gives warmth and aesthetic appearance to the place. Generally, a fireplace has a wood mantel that further enhances the pleasing appearance of the fireplace. The cabinet according to the present invention is designed to depict the fireplace wherein the cabinet matches with the interiors of the residential place. Moreover, the cabinet does not occupy an additional place on wall, but may be built around the existing space of fireplace or wood mantel. The cabinet according to present invention may comprise a faux fireplace like appearance.

A side wall of the cabinet (is shown subsequently) removed to illustrate one embodiment of the air conditioning system housed in the cabinet. A front side of the cabinet is configured to mount an illustrative model of a fireplace in 2D or 3D representation, providing a faux appearance of the fireplace. The rectangular wooden cabinet is supported on four legs and comprises an image of fireplace on the front side providing the cabinet a faux fireplace like appearance. To further enhance the fireplace-like appearance, lights may be disposed inside the front panel. The front side may act as a frame having a transparent cover made of glass or plastic, and the illustrative model of the fireplace may be enclosed inside the frame and further suitable lights may also be enclosed within the frame. Alternatively, the top side may be configured to mount an electronic display monitor. The electronic display monitor may comprise an LED TV for example; other technologies may be used. The cabinet may be designed to mount the different size electronic displays.

The cabinet encloses a heat exchanging coil, such as an evaporator coil of an HVAC system and a blower, an air inlet is shown on the bottom side of the cabinet and an air outlet is shown on the top area of the front side of the cabinet. The evaporator coil may be placed in between the blower and the air outlet such as the air sucked in passes through the heat exchanger causing cooling or heating of the air. The air outlet may be covered with a mesh. Alternatively, horizontal and vertical fins may be provided to direct flow of the air. On the top area of the front side of the cabinet there are three shelves on the lateral parts of front side.

The heat exchanger may be produced similar to any conventional heat exchanger, for example, the use of the multiple copper tubes having outer surface of tubes provided with aluminum fins to increase the surface area for heat exchange may be used. Similarly, the blower may be any conventional blower, such as blower having 3-4 blades and powered by an electric motor. The air inlet is shown in the bottom side of the cabinet, however the air inlet may be provided on any side of the cabinet and more than one air inlet may be provided on one or more side of the cabinet. The air inlet may further include air filters that provide filtering of dust particles from the air received by suction of the blower, thus reducing any particulate material getting deposited inside the cabinet, on the components of the cabinet or carried to the interiors of the place. Such type of filters and the assembling of such filters are obvious to a skilled person, for example foam or fabric based filters, HEPA filters may be used.

The apparatus may be further provided with a control unit, which includes a thermostat to determine the interior temperature of an area and an input module for setting the desired temperature. The control unit is operably connected to the apparatus and may automatically control activity. The control unit shall keep running the apparatus until the preset temperate of the interior is reached and then keep the apparatus in standby mode and again starts the system if the interior temperature drops down. Thus, providing an automated functioning of the apparatus that may decrease electricity consumption and saves money. Furthermore, the control unit may be remotely operated using a remote control, or any other handheld electronic device such as a smart phone. Suitable mobile phone software application may also be accordingly provided for connecting to the control unit.

The cabinet of the present invention may be used to enclose any other kind of air conditioning systems or part of the air conditioning systems for example, HVAC systems, heat pumps, hydronic based heating systems etc. The split type HVAC systems generally consist of an outdoor unit having a compressor, a condenser and an expansion valve. The indoor unit includes an evaporator coil and a blower. The cabinet according to present invention encloses the indoor unit; however, the cabinet may also be used to enclose the complete air conditioning system as in non-spit HVAC. The indoor unit and outdoor units may be connected through two or more tubing. Similarly, the present invention encompasses other types of air-conditioning systems including split type air containing systems, such as heat pumps, mini-split heat pumps etc.

The cabinet according to the present invention may be made from wood material; however other suitable materials such as plastic and metals may also be used. The outer surface of the cabinet may be provided with protective coverings such as paint, polish, or carved to form various designs. Furthermore, the outer surface may be produced in different colors. Similarly, the shape and size of the cabinet may vary. The corners of the cabinet may be smooth, and the edges may be provided with decorative strips. The legs of the cabinet may be optional and the cabinet may be mounted on the floor or an elevated platform.

The wood mantel according to the present invention may be constructed similar to the cabinet comprising a shape and size similar to a conventional wood mantel with multiple sides, an interior hollow volume and one or more sides are configured to provide the air inlet and air outlet, and the tubing may pass through a hole in any side of the wood mantel. The air-conditioning system may be enclosed in the interior volume of the wood mantel.

Unlike, the cabinet having the illustrating model of the fireplace on front side, the outer surface of the wood mantel according to present invention depicts any conventional wood mantel and may be produced in different colors, designs, size and shapes as desired by the user. Similar to the fireplace depicted cabinet, the wood mantel may also enclose different kinds of air conditioning systems; preferably the wood mantel may enclose the indoor unit of the air conditioning systems. In one exemplary embodiment the wood mantel is produced as a rectangular elongated cabinet having six sides. The four sides are elongated and have equal length forming the hollow body, and the two small panels cover the opposite ends of the hollow body.

The wood mantel may preferably comprise wood material; however other suitable materials may also be used. Furthermore, the wood mantel may be mounted on the wall preferably above the fireplace. In one exemplary embodiment the wood mantel may also be adapted to mount electronic display systems such as TV.

In another embodiment, the present invention provides a hydronic based heating system that may be housed in the cabinet or the wood mantel according to the present invention. The hydronic based heating system includes a source of heating. The heating source may be an outdoor or indoor furnace adapted for burning fossil fuels such as wood, coal, fuel oil, natural gas, LP gas, or an electric boiler, or an electric, natural gas, LP gas or fuel oil domestic water heater. The use of outdoor furnaces is quite common in areas having extreme climates and is used for providing hot water. The selection of a source of heat may depend upon the requirements and the size of the buildings. A smaller building or a room may preferably have an indoor electric water heater which is convenient, compact and provides pollution free heating of water. A large house, like a villa, may require an outdoor furnace that may be economical in comparison to electrical heating. Furthermore, existing water heaters or furnaces installed in a building may also be employed with certain modification and keeping in view various embodiments of present invention.

A heat exchange fluid circulation system circulates a heat exchange fluid as means to transfer heat from the source of heat to the air wherein the heat exchange fluid may be water. Water is known to have high heat capacity and is generally used as a heat-transferring medium. Moreover, the use of water is economic and environmental friendly, although other fluids having higher boiling point like heavy oils may also be used. The fluid may be heated through a first heat exchanger that may be located near the source of heat, wherein the source of heat causes heating of the fluid while passing through the heat exchanger.

The heat exchanger may be positioned adjacent to the furnace, for example, above the fire. The first heat exchanger may be made from any conductive material and the choice of metal may depend upon the source of heat. Preferably the heat exchanger may comprise multiple tubes with circulating fluid and the tubes having outer aluminum fins for increasing the surface area for heat absorption.

Another heat exchanger is used for exchanging the heat between the air and fluid circulating in the heat exchanger. The surface area of the second heat exchanger is large to provide enough heat transfer to the surrounding air. The second heat exchanger may be made similar to first heat exchanger or may be constructed differently, for example, the second heat exchanger may be produced from multiple copper tubes and outer aluminum fins. A blower is provided which causes the air to pass along the second heat exchanger. The air coming in proximity to the surface of second heat exchanger gets heated. The heated air is then delivered to the interior of the building through the air outlet in the cabinet.

The blower may be a fan having multiple blades, which forces the air towards the second heat exchanger. The blower and second heat exchanger may be disposed in a duct having an inlet and outlet. The blower may receive the air from the same interiors of building thus circulating the same air in interiors. Circulating the interior air may be advantageous being warmer than outer air; however, such a process may lead to buildup of carbon dioxide and other odors. In another embodiment the blower may receive air partially from the interiors and rest from outside, thus mixing a proportion of fresh air. Still in another embodiment, the blower may receive all the air from outside providing fresh air to the interiors.

The first heat exchanger and the second heat exchanger are connected through tubing forming a closed-loop fluid circulation system. The tubes may be copper tubes optionally having outer insulation. Further, the circulation system is interrupted by a pump, the pump refers to any device capable of pumping fluid such as water in a closed fluid circulation loop system, and the pump should be capable of pumping hot fluid. The pump causes the fluid contained in the circulation system to move from the first heat exchanger to second heat exchanger and from the second heat exchanger to the first heat exchanger, thus transferring the heat from the source of heat to the air and the fluid serving as the carrier of heat. Further, the circulation system may include a reservoir for storing a predetermined amount of heat exchange fluid.

The indoor unit of the hydronic based heating system including the second heat exchanger and the blower may be housed in the cabinet or the wood mantel, according to the present invention while the outdoor unit, which includes the source of heat and the first heat exchanger, may be mounted outside the building. The outdoor unit and the indoor unit may be connected through tubing as discussed above for connecting the two heat exchangers.

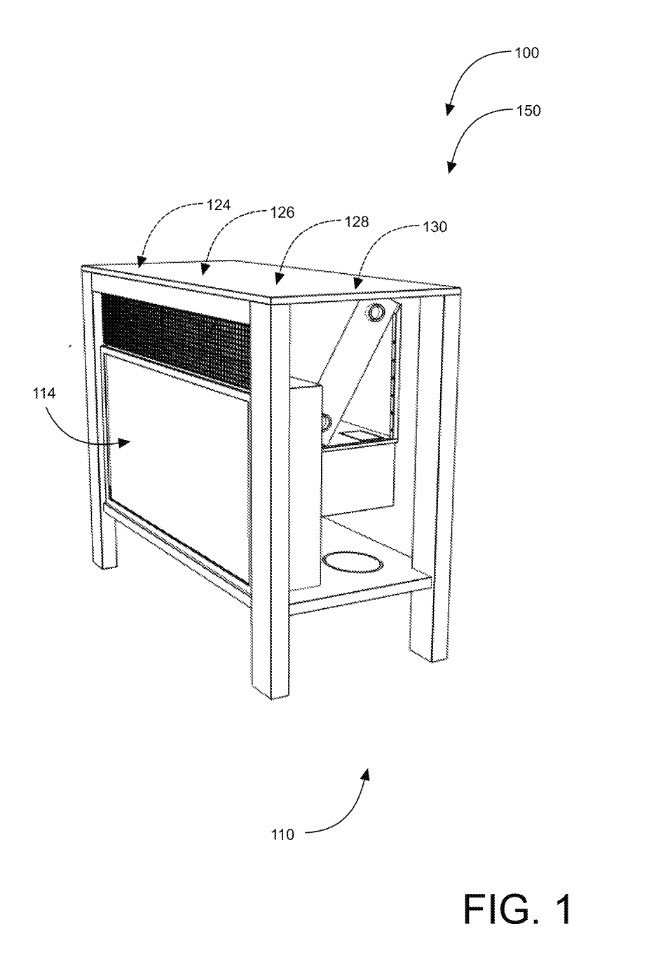

Referring to the drawings by numerals of reference there is shown in FIG. 1, wooden-cabinet for air conditioning system 100 comprising wood-cabinet for air conditioning assembly 110 having cabinet 114, air-conditioning system 124 with indoor unit 130, blower 132, and heat exchanger 134, outdoor unit having compressor, condenser, and expansion valve, wood mantel, and illustrative model 180.

Wooden-cabinet for air conditioning system 100 comprises wood-cabinet for air conditioning assembly 110. Wood-cabinet for air conditioning assembly 110 comprises cabinet 114. Cabinet 114 comprises air-conditioning system 124, illustrative model 180 depicting fireplace 182, and wood mantel Air-conditioning system 100 comprises indoor unit 130 and outdoor unit. Indoor unit 130 comprises blower 132 and heat exchanger 134. Outdoor unit comprises compressor, condenser and expansion valve. Cabinet 114 comprises an aperture configured to permit at least two of the tubes of air conditioning system 124 to pass through. Cabinet 114 is configured to house indoor unit 130 of air conditioning system 124.

Air conditioning system 124 further comprises outdoor unit. Indoor unit 130 and outdoor unit are in fluid communication through at least two tubes. Wood mantel comprises a plurality of side walls 164 defining wood mantel having an inner volume. Wood mantel comprises at least one air inlets defined on at least one sidewalls 164 of cabinet 114. Wood mantel comprises at least one air outlets defined on at least one of the sidewalls 164 of cabinet 114. Wood mantel comprises an aperture defined on any of the sidewall(s) 164 of cabinet 114; the aperture configured to permit two or more tubes of air conditioning system 124 to pass-through. Wooden-cabinet for air conditioning system 100 is structured and arranged for enclosing air conditioning system 124 to prevent damage to air conditioning system 124. Air conditioning system 124 further comprises at least one air filter configured on at least one air inlet.

Cabinet 114 comprises wood in preferred embodiments but may comprise other materials in alternate embodiments. Illustrative model 180 is a three dimensional model of fireplace 182. Illustrative model 180 further comprises a plurality of illuminations 184. Air conditioning system 124 is a split type HVAC. Air conditioning system 124 is a spilt type heat pump. Air conditioning system 124 may be a hydronic based heating system. Wood mantel is configured to enclose one or more components of air conditioning system 124. Indoor unit 130 is in fluid communication to outdoor unit of the hydronic based heating system; outdoor unit comprising heat source 166 and first heat exchanger 168 in spatial relationship to heat source 166. Indoor unit 130 and outdoor unit are in fluid communication through at least two tubings (tubes), the two or more tubings pass through one or more the apertures defined on any sidewall of the cabinet 164. Cabinet 114 is produced in the form a faux-fireplace in preferred embodiments. Cabinet 114 is preferably made of wood and depicted in the form of wood mantel, wood mantel configured to be wall mountable.

Air conditioning system 124 further comprises control unit 126, control unit 126 configured to operate air conditioning system 124 and comprises a thermostat and an input module. The input module adapted to receive a temperature input. Control unit 126 is able to be remotely operated using a remote control and alternately a smart phone

Wooden-cabinet for air conditioning system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different material/HVAC combinations, parts may be sold separately, etc., may be sufficient.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A wooden-cabinet for air conditioning system comprising:
a wood-cabinet for air conditioning assembly having;
a cabinet;
an air-conditioning system;
an indoor unit;
a blower; and
a heat exchanger;
an outdoor unit;
a compressor;
a condenser; and
an expansion valve;
a wood mantel; and
an illustrative model;
wherein said wooden-cabinet for air conditioning system comprises said wood-cabinet for air conditioning assembly;
wherein said wood-cabinet for air conditioning assembly comprises said cabinet;
wherein said cabinet comprises said air-conditioning system, said illustrative model depicting a fireplace, and said wood mantel;
wherein said air-conditioning system comprises said indoor unit and said outdoor unit;
wherein said indoor unit comprises said blower and said heat exchanger;
wherein said outdoor unit comprises said compressor, said condenser and said expansion valve;
wherein said cabinet comprises an aperture configured to permit at least two of said tubes of said air conditioning system to pass through;
wherein said cabinet is configured to house an indoor unit of said air conditioning system;
wherein said air conditioning system further comprises said outdoor unit;
wherein, said indoor unit and said outdoor unit are in fluid communication through at least two of said tubes;
wherein said wood mantel comprises a plurality of side walls defining said wood mantel having an inner volume;
wherein said wood mantel comprises at least one air inlets defined on at least one sidewalls of said cabinet;
wherein said wood mantel comprises at least one air outlets defined on at least one of said sidewalls of said cabinet;
wherein said wood mantel comprises an aperture defined on any said sidewall of said cabinet, said aperture configured to permit two or more tubes of said air conditioning system to pass-through; and
wherein said wooden-cabinet for air conditioning system is structured and arranged for enclosing said air conditioning system to prevent damage to said air conditioning system.

2. The wooden-cabinet for air conditioning system of claim 1 wherein said cabinet comprises wood.

3. The wooden-cabinet for air conditioning system of claim 1 wherein said air conditioning system further comprises at least one air filter configured on at least one air inlet.

4. The wooden-cabinet for air conditioning system of claim 1 wherein said illustrative model is an image of said fireplace.

5. The wooden-cabinet for air conditioning system of claim 4 wherein said illustrative model is a three dimensional model of said fireplace.

6. The wooden-cabinet for air conditioning system of claim 5 wherein said illustrative model further comprises a plurality of illuminations.

7. The wooden-cabinet for air conditioning system of claim 5 wherein said air conditioning system is a split type HVAC.

8. The wooden-cabinet for air conditioning system of claim 6 wherein said air conditioning system is a spilt type heat pump.

9. The wooden-cabinet for air conditioning system of claim 8 wherein said air conditioning system is a hydronic based heating system.

10. The wooden-cabinet for air conditioning system of claim 1 wherein said wood mantel is configured to enclose one or more components of said air conditioning system.

11. The wooden-cabinet for air conditioning system of claim 9 wherein said indoor unit is in fluid communication to said outdoor unit of said hydronic based heating system, said outdoor unit comprising a heat source and a first heat exchanger in spatial relationship to said heat source.

12. The wooden-cabinet for air conditioning system of claim 1 wherein said indoor unit and said outdoor unit are in fluid communication through at least two tubings wherein said two or more tubing pass through one or more said apertures defined on any sidewall of said cabinet.

13. The wooden-cabinet for air conditioning system of claim 1 wherein said cabinet is produced in the form a faux-fireplace.

14. The wooden-cabinet for air conditioning system of claim 2 wherein said cabinet is made of said wood and depicted in the form of a wood mantel, said wood mantel configured to be wall mountable.

15. The wooden-cabinet for air conditioning system of claim 1 wherein said air conditioning system further comprises a control unit, said control unit configured to operate said air conditioning system and comprises a thermostat and an input module, said input module adapted to receive a temperature input.

16. The wooden-cabinet for air conditioning system of claim 15 wherein said control unit is able to be remotely operated using a remote control and alternately a smart phone.

17. A wooden-cabinet for air conditioning system comprising:
a wood-cabinet for air conditioning assembly having;
a cabinet;
an air-conditioning system;
an indoor unit;
a blower; and
a heat exchanger;
an outdoor unit;
a compressor;
a condenser; and
an expansion valve;
a wood mantel; and
an illustrative model;
wherein said wooden-cabinet for air conditioning system comprises said wood-cabinet for air conditioning assembly;
wherein said wood-cabinet for air conditioning assembly comprises said cabinet, said wood mantel, and said illustrative model;
wherein said illustrative model is a three dimensional model of said fireplace;
wherein said illustrative model further comprises a plurality of illuminations;
wherein said cabinet comprises wood;
wherein said cabinet is produced in the form a faux-fireplace;
wherein said cabinet comprises said air-conditioning system, said illustrative model depicting a fireplace, and said wood mantel;
wherein said air-conditioning system comprises said indoor unit and said outdoor unit;
wherein said air conditioning system further comprises a control unit, said control unit configured to operate said air conditioning system and comprises a thermostat and an input module, said input module adapted to receive a temperature input;
wherein said control unit is able to be remotely operated using a remote control and alternately a smart phone;
wherein said indoor unit and said outdoor unit are in fluid communication through at least two tubings wherein said two or more tubing pass through one or more said apertures defined on any sidewall of said cabinet;
wherein said air conditioning system further comprises at least one air filter configured on at least one air inlet;
wherein said air conditioning system is a split type HVAC;
wherein said indoor unit comprises said blower and said heat exchanger;
wherein said indoor unit is in fluid communication to said outdoor unit of said hydronic based heating system, said outdoor unit comprising a heat source and a first heat exchanger in spatial relationship to said heat source;
wherein said outdoor unit comprises said compressor, said condenser and said expansion valve;
wherein said cabinet comprises an aperture configured to permit at least two of said tubes of said air conditioning system to pass through;
wherein said cabinet is configured to house an indoor unit of said air conditioning system;
wherein said air conditioning system further comprises said outdoor unit;
wherein, said indoor unit and said outdoor unit are in fluid communication through at least two of said tubes;
wherein said wood mantel comprises a plurality of side walls defining said wood mantel having an inner volume;
wherein said wood mantel is configured to enclose one or more components of said air conditioning system;
wherein said wood mantel comprises at least one air inlets defined on at least one sidewalls of said cabinet;
wherein said wood mantel comprises at least one air outlets defined on at least one of said sidewalls of said cabinet;
wherein said wood mantel comprises an aperture defined on any said sidewall of said cabinet, said aperture configured to permit two or more tubes of said air conditioning system to pass-through; and
wherein said wooden-cabinet for air conditioning system is structured and arranged for enclosing said air conditioning system to prevent damage to said air conditioning system.
